(19) United States
(12) Patent Application Publication
(10) Pub. No.: US 2008/0231971 A1
(43) Pub. Date: Sep. 25, 2008

(54) 3-Dimensional Image Detector

(76) Inventors: Kwang-Don Park, Bucheon-Si (KR); Jong-Hwa Choi, Seoul (KR)

Correspondence Address: IPLA P.A., 3580 WILSHIRE BLVD., 17TH FLOOR, LOS ANGELES, CA, 90010, US

(21) Appl. No.: 11/995,217

(22) PCT Filed: Jul. 10, 2006
(86) PCT No.: PCT/KR06/02676

§ 371 Date: Jan. 10, 2008

(30) Foreign Application Priority Data
Jul. 11, 2005 (KR) 10-2005-0062113
Jul. 10, 2006 (KR) PCT/KR2006/002676

(51) Int. Cl. G02B 13/00

(52) U.S. Cl. 359/737

(57) ABSTRACT

The present invention relates to a 3-dimensional image detector adapted to simultaneously detect images of an object viewed from multi-directions, including: a lens barrel; a refraction section mounted at a front end side of the lens barrel; a lens section mounted at the rear of the refraction section; and an image-detecting section mounted at the rear of the lens section for acquiring an image passed through the refraction section and the lens section.

### TECHNICAL FIELD

The present invention relates to a 3-dimensional image detector, and more particularly to, a 3-dimensional image detector adapted to simultaneously detect images of an object viewed from multi-directions, including: a lens barrel including a first lens barrel and a second lens barrel fit into the first lens barrel; a refraction section mounted at a front end side of the first lens barrel; a lens section mounted at a front end side of the second lens barrel in such a fashion as to be arranged at the rear of the refraction section; and an image-detecting section mounted at a rear portion of the lens section for acquiring an image passed through the refraction section and the lens section, whereby images refracted at certain angles while passing through the refraction section are simultaneously acquired.

### BACKGROUND ART

According to a conventional method of acquiring and detecting an image of an object, respective image detectors can acquire only an image viewed from one direction. In this case, in order to acquire an image of an object viewed different angles, an image detector must be moved to other position or the object must be rotated at different angles,

or as shown in FIG. 4, a separate image detector must be provided additionally so as to view the object at different angles.

In case where an image detector itself is moved to other position so as to acquire images of the object viewed at various angles, a driving apparatus for moving the image detector and a controller for controlling the driving apparatus are needed to be installed. After the image detector is moved to other position, there should be repeatedly performed an image-detecting process including adjusting a focus length of the object by using a series of lenses, adjusting an aperture of an iris diaphragm to control the depth of field, etc., so as to detect an image of the object.

Thus, the conventional image acquiring and detecting method entails problems in that a surrounding device is complicated, installation cost is increased, the time spent for acquiring and detecting an image of an object is delayed.

Alternatively, in case where the object itself is rotated or is moved to other position in a state where an image detector is fixed in position so as to acquire images of the object viewed at various angles, there occurs the same problem as in the case where the image detector itself is moved to other position.

That is, there should be repeatedly performed an image—

acquiring process of acquiring a first image of the object in a state where the object is fixed in a reference position, and then acquiring a second image by rotating the object at a given angle or moving the object to other position. Therefore, such a latter method also entails problems in that separate equipment must be additionally installed to move and control the object, and the separate time is required to acquire a second image of the object, which results in a delay in the time to acquire and detect the image of the object.

In case where a plurality of image detectors are installed separately so as to acquire images of the object viewed at various angles and positions, there is a merit of simultaneously acquiring and detecting a plurality images. Nevertheless, there is also caused a demerit that a plurality of image detectors must be provided to thereby make surrounding devices complicated and increase the installation cost.

### DISCLOSURE OF INVENTION

### Technical Problem

Accordingly, the present invention has been made in view of the above problems occurring in the prior art, and it is an object of the present invention to provide a means for acquiring and detecting images of an object viewed at various angles using one image detector.

Another object of the present invention is to provide a means for simultaneously acquiring and detecting images of an object viewed at various angles using one image detector.

Another object of the present invention is to provide an image detector which is simple in construction and control.

### Technical Solution

To accomplish the above object, according to the present invention, there is provided a 3-dimensional image detector adapted to simultaneously detect images of an object viewed from multi-directions, including: a lens barrel including a first lens barrel and a second lens barrel fit into the first lens barrel; a refraction section mounted at a front end side of the first lens barrel; a lens section mounted at a front end side of the second lens barrel in such a fashion as to be arranged at the rear of the refraction section; and an image-detecting section mounted at a rear portion of the lens section for acquiring an image passed through the refraction section and the lens section.

### BRIEF DESCRIPTION OF THE DRAWINGS

FIG. 1 is a longitudinal cross-sectional view illustrating the construction of a 3-dimensional image detector according to a preferred embodiment of the present invention;

FIG. 2 is a schematic cross-sectional view illustrating a refraction section constituting a 3-dimensional imagedetector according to a preferred embodiment of the present invention;

FIG. 3 is a schematic diagrammatic view illustrating an example of images detected through an image-detecting section constituting a 3-dimensional image detector according to a preferred embodiment of the present invention; and

FIG. 4 is a schematic diagrammatic view illustrating the construction of a conventional image-detecting system for performing an image-detecting method in which an image of an object is acquired and detected according to the prior art.

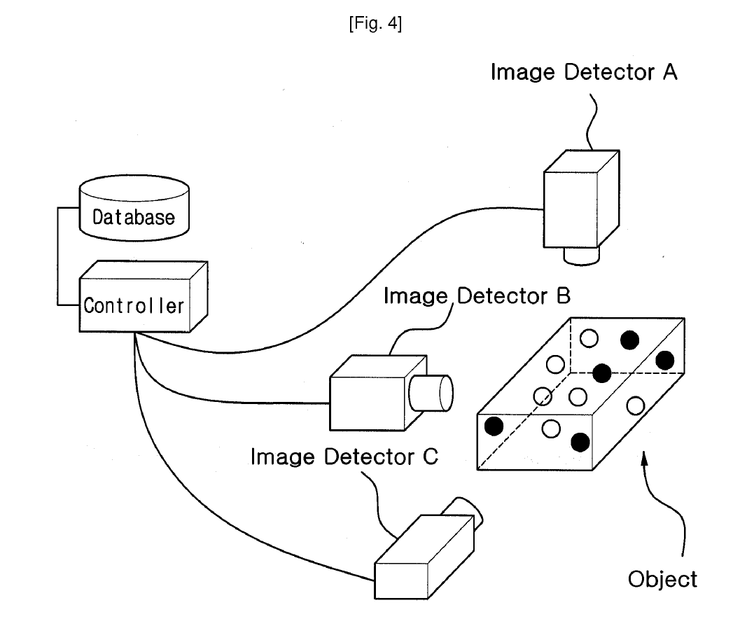

### MODE FOR THE INVENTION

Hereinafter, the present invention will be described in detail with reference to the accompanying drawings.

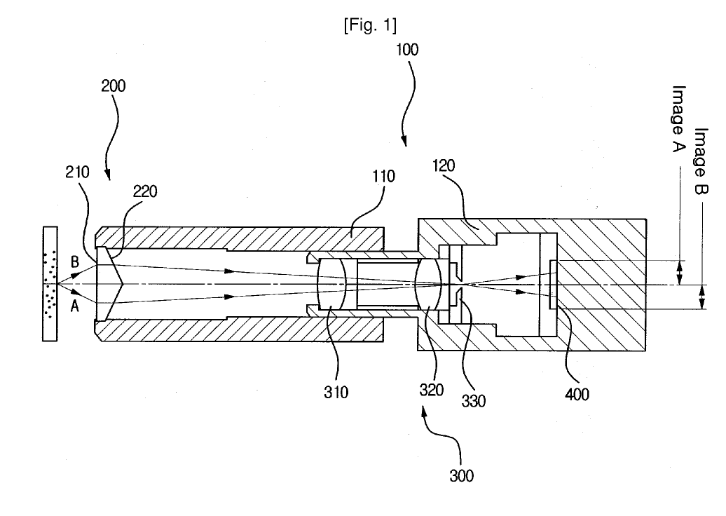

As shown in FIG. 1, there is provided a 3-dimensional image detector which is spaced apart from an object by a predetermined distance.

A lens barrel 100, which constitutes a body of a three dimensional detector of the present invention, has respective constituent elements included therein.

The lens barrel 100 is substantially formed in a hollow cylindrical shape, but is not limited thereto. The lens barrel 100 may take various geometric cross-sections such as quadrangle, hexagon, octagon, etc., if necessary.

In addition, the lens barrel 100 may consist of a first lens barrel 110 having a refraction section 200 mounted therein and a second lens barrel 120 having a lens section 300 mounted therein.

In this case, the lens barrel 100 is constructed such that the first lens barrel 110 is fit around an end portion of the second lens barrel 120 so that it can move slidably in backward and forward directions to cause the distance between the refraction section 200 and the lens section 300 to easily be adjusted.

That is, the adjustment of the entire length of the lens barrel 100 results in an adjustment of the distance between an object and a prism, which leads to detection of an acquired image of the object viewed from various angles by means of an image-detecting section 400.

In other words, a refraction angle and a traveling path of light vary depending on the distance between the object and the refraction section 200, and the distance between the refraction section 200 and the lens section 300, so that an image of the object detected and acquired by the image-detecting section 400 varies.

The refraction section 200 is mounted at a front end side of the first lens barrel 110.

Light incident to the first lens barrel 110 of the lens barrel 100 first penetrates through the refraction section 200 which in turn allows the incident light to be refracted at a certain angle to thereby change its traveling path.

A prism is used to refract or disperse a beam of the incident light. The prism is a transparent body having two or more optical planar faces in which at least one pair of faces are not parallel with each other. An optical glass is typically used as the material of the prism. In place of the glass, crystal, halite, etc., is generally used for an ultraviolet ray or an infrared ray.

A front surface of the prism used in a preferred embodiment of the present invention is a planar face 210, and a rear surface thereof is a polygonal face.

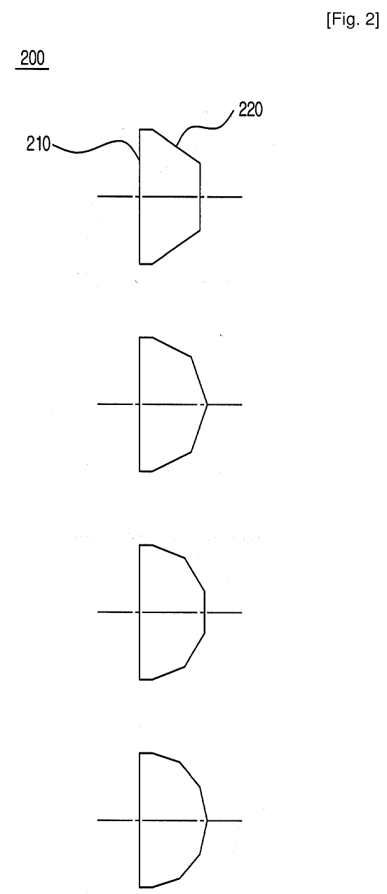

As shown in FIG. 1, the prism has, but is not limited to, a polygonal surface 220 consisting of two symmetrical faces. As shown in FIG. 2, a polygonal surface consisting of several faces may be selectively used freely, if necessary.

The lens section 300 is mounted at a front end side of the second lens barrel 120 in such a fashion as to be arranged at the rear of the refraction section 200 so as to transmit the incident light refracted from the refraction section 200 to the image detecting section 400 which in turn has an image formed thereon.

The lens section 300 performing such a function can employ a proper combination of a variety of kinds and shapes of lenses. In a preferred embodiment of the present invention, as shown in FIG. 1, the lens section 300 is composed of a combination of a first-imaging lens 310 and a second-imaging lens 320 so that the light passed through the refraction section 200 is transmitted to the image-detecting section 400 to thereby distinctly form an image of an object thereon.

An iris diaphragm 330 is mounted at the back of the second-imaging lens 320. The iris diaphragm 330 functions to adjust the amount of a transmitted light passed through the lens section 300 as well as to modify a depth of field which is the amount of distance between the nearest and farthest objects that appear in acceptably sharp focus in a photograph.

The depth of field varies depending on aperture of the iris diaphragm, focal length and shooting distance.

That is, (a) the smaller the aperture becomes, the deeper the depth of field becomes, and the larger the aperture, the shallower the depth of field. (b) The greater the shooting distance becomes, the deeper the depth of field becomes, and the smaller the shooting distance, the shallower the depth of field. And the shorter the lens focal length becomes, the deeper the depth of field, and the longer the lens focal length, the shallower the depth of field.

Thus, according to a necessary depth of field, it is important to determine the first-imaging lens 310, the second-imaging lens 320 and the iris diaphragm 330.

The image-detecting section 400 may be any one of a charge coupled device (CCD) or a complementary metal oxide semiconductor (CMOS).

The CCD is an optical sensor semiconductor device for converting light into an electric signal in a digital camera, and corresponds to an optical element of photosensitizing a film in terms of a general camera.

The incident light transmitted to the image-detecting section 400 from the first-imaging lens 310, the second-imaging lens 320 and the iris diaphragm 330 is converted into an electrical signal by means of the CCD through the strength of the light. Then, the converted electrical signal is re-converted into an image file through an analog-to-digital converter (ADC) which converts an analog signal into a digital signal, i.e., 0 and 1 so as to be stored in a memory.

In this case, white light of a photographed image is separated into different colors by means of an RGB filter attached on the CCD. Then, the separated colors are converted into electrical signals by means of several hundreds and thousands of photosensitive elements constituting the CCD.

The performance of the CCD varies depending on the number of image-constituting pixels contained in the same cell region. For example, a purchaser determines whether the number of pixels contained in the CCD is three millions or four millions upon the purchase of the digital camera.

As a degree of integration of the pixels is increased, a sharper image can be obtained. Also, the size of the CCD itself as well as the degree of integration of the pixels has a great effect on image quality.

The complementary metal oxide semiconductor (CMOS) is a kind of low-power consumption type image pickup device. The CMOS requires only electric power corresponding to about one tenth of that of the CCD does. The CMOS is used in web cameras, common-type digital cameras, camera cellular phones, etc.

As such, the image-detecting section 400 converts the photographed image into a digital signal using the CCD or the CMOS, and then stores the converted digital signal in the memory.

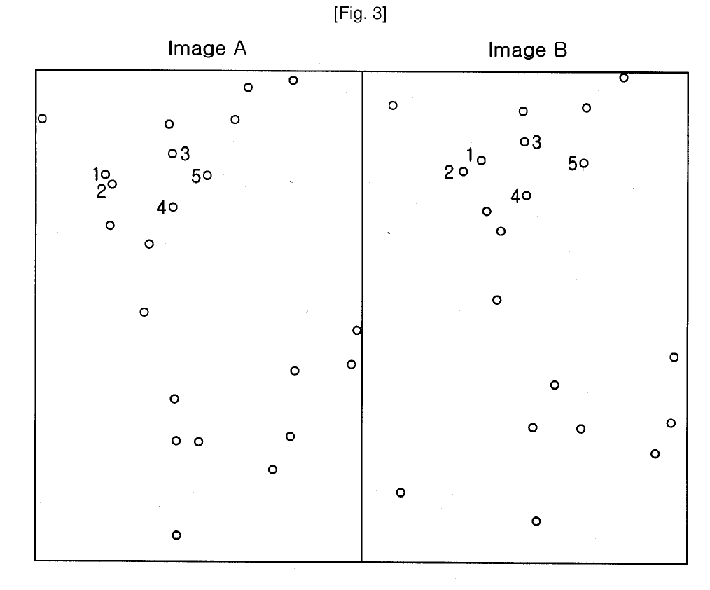

FIG. 3 is a schematic diagrammatic view illustrating an example of photographed images detected by the image-detecting section 400 according to a preferred embodiment of the present invention.

It can be seen from FIG. 3 that images of an object viewed from different directions can be obtained depending on a traveling path of the incident light passed through the refraction section 200 and the lens section 300.

That is, in case where a plurality of identification particles are distributed in a transparent body of the detected object, their arrangement varies depending on an angle at which the object is viewed.

In FIG. 3, the example of the photographed images show that when the rear side surface of the refraction section 200 is composed of two planes, two images can be obtained depending on the traveling path of the light.

If the rear side surface of the refraction section 200 is composed of a plurality of planes, a plurality of images can be obtained depending on the traveling path of the light correspondingly.

The image data obtained in this manner may be stored in the memory, and may be, of course, transmitted to other system through a communication network including the Internet.

### INDUSTRIAL APPLICABILITY

As described above, the 3-dimensional image detector according to the present invention has a following technical effect:

Firstly, it is possible to provide a means for acquiring and detecting images of an object viewed at various angles using one image detector.

That is, the present invention includes the refraction section 200 mounted in front of the lens section 300, so that images of the object viewed from a variety directions according to the refraction angle of light can be obtained through the image-detecting section 400.

Secondly, it is possible to simultaneously acquire and detect images of an object viewed at various angles using one image detector.

That is, the present invention allows one image-detecting section to simultaneously acquire and detect images of an object viewed at different angles according to the refraction angle of the refraction section 200.

Thirdly, it is possible to provide an image detector which is simple in construction and control.

That is, since the present invention enables one image detector to simultaneously acquire and detect images of an object viewed at different angles, a separate apparatus for moving or rotating an image detector or an object being detected or a control means is unnecessary, to thereby further simplify its structure, remarkably reduce the cost spent for repairing and maintaining the equipment to achieve economic efficiency.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

1. A 3-dimensional image detector adapted to simultaneously detect images of an object viewed from multi-directions, comprising: a lens barrel; a refraction section mounted at a front end side of the lens barrel; a lens section mounted at the rear of the refraction section; and an image-detecting section mounted at the rear of the lens section for acquiring an image passed through the refraction section and the lens section.

2. The 3-dimensional image detector as defined in claim 1, wherein the refraction section is constructed of a prism whose front surface is a planar face and whose rear surface is a polygonal face so as to refract or disperse a beam of a light incident into the refraction section.

3. The 3-dimensional image detector as defined in claim 2, wherein the lens section comprises: a first-imaging lens; a second-imaging lens mounted at the rear of the first-imaging lens; and an iris diaphragm mounted at the rear of the second-imaging lens.

4. The 3-dimensional image detector as defined in claim 1 wherein the image-detecting section is any one of a charge coupled device (CCD) or a complementary metal oxide semiconductor (CMOS).

5. The 3-dimensional image detector as defined in claim 4, wherein the lens barrel comprises: a first lens barrel in which the refraction section is mounted; and a second lens barrel in which the lens section is mounted. whereby the first lens barrel is fit around the second
